(19) United States
(12) Patent Application Publication
(10) Pub. No.: US 2024/0049342 A1
(43) Pub. Date: Feb. 8, 2024

(54) DRX CONFIGURATION METHOD AND APPARATUS, COMMUNICATION DEVICE AND STORAGE MEDIUM

(71) Applicant: Beijing Xiaomi Mobile Software Co., Ltd., Beijing (CN)

(72) Inventor: Xing YANG, Beijing (CN)

(73) Assignee: Beijing Xiaomi Mobile Software Co., Ltd., Beijing (CN)

(21) Appl. No.: 18/257,224

(22) PCT Filed: Dec. 14, 2020
(86) PCT No.: PCT/CN2020/136261

§ 371 Date: Jun. 13, 2023

(51) Int. Cl. H04W 76/28; H04W 72/25

(52) U.S. Cl. CPC H04W 76/28; H04W 72/25

(57) ABSTRACT

Aspects of the disclosure are directed to a DRX configuration method and an apparatus, a communication device and a storage medium. The method can be applied to a first terminal, and includes determining DRX configuration of a second terminal according to time domain location information used by the second terminal on Sidelink (SL) to sense transmission resources.

### CROSS REFERENCE TO RELATED APPLICATION

The present disclosure is the U.S. national phase application of International Application No. PCT/CN2020/136261 filed on Dec. 14, 2020, the content of which is incorporated herein by reference in its entirety for all purposes.

### BACKGROUND

### Technical Field

The present disclosure relates, but is not limited, to the field of wireless communication, in particular to a DRX (Discontinuous Reception) configuration method, an apparatus, a communication device, and a storage medium.

### Description of the Related Art

In wireless communication, a terminal can activate a timer for corresponding functions based on the DRX configuration provided by the network, thereby achieving time control for various functions such as wake-up, dormancy, and retransmission.

With the development of wireless communication technology, terminals can communicate directly through the Sidelink (SL). Multiple different terminals can transmit data to each other.

### SUMMARY

The present disclosure provides a DRX configuration method, an apparatus, a communication device, and a storage medium.

According to a first aspect of the present disclosure, a DRX configuration method is provided, which is applied to a first terminal, and includes determining, according to time domain location information used by a second terminal on Sidelink (SL) for sensing a transmission resource, a DRX configuration of the second terminal.

According to a second aspect of the present disclosure, a DRX configuration method is provided, which is applied to a second terminal, and includes sending time domain location information used by the second terminal for sensing a transmission resource to a DRX configuration node, wherein the time domain location information is used by the DRX configuration node for determining a DRX configuration of the second terminal.

According to a third aspect of the present disclosure, a DRX configuration method is provided, which is applied to a base station, and includes receiving time domain location information for indicating sensing on a transmission resource on Sidelink (SL) by a second terminal, wherein the time domain location information is at least for determination of the DRX configuration of the second terminal.

According to a fourth aspect of the present disclosure, a DRX configuration apparatus is provided, which is applied to a first terminal, and includes a first determination module configured to determine, according to time domain location information used by a second terminal on Sidelink (SL) for sensing a transmission resource, a DRX configuration of the second terminal.

According to a fifth aspect of the present disclosure, a DRX configuration apparatus, which is applied to a second terminal, and includes a sending module configured to send time domain location information used by the second terminal for sensing a transmission resource to a DRX configuration node, wherein the time domain location information is used by the DRX configuration node for determining a DRX configuration of the second terminal.

According to a sixth aspect of the present disclosure, a DRX configuration apparatus is provided, which is applied to a base station, and includes a receiving module configured to receive time domain location information for indicating sensing on a transmission resource on Sidelink (SL) by a second terminal, wherein the time domain location information is at least for determination of the DRX configuration of the second terminal.

According to a seventh aspect of the present disclosure, a communication device is provided, which at least includes a processor and a memory for storing executable instructions capable of running on the processor, wherein when the executable instructions run on the processor, steps of any of the DRX configuration methods mentioned above are caused to be executed.

According to an eighth aspect of the present disclosure, a non-transitory computer-readable storage medium is provided, which has computer executable instructions stored thereon, when the computer executable instruction are executed by a processor, steps of any of the DRX configuration methods mentioned above are caused to be executed.

### BRIEF DESCRIPTION OF THE DRAWINGS

The drawings, which are incorporated in and constitute a part of this specification, illustrate exemplary embodiments consistent with the present disclosure and serve together with the specification to explain principles of the present disclosure.

FIG. 1 is a schematic diagram of a structure of a wireless communication system according to exemplary embodiments;

FIG. 2 is a schematic diagram of a structure of another wireless communication system according to exemplary embodiments;

FIG. 3 is a flowchart of a DRX configuration method according to exemplary embodiments;

FIG. 4 is a flowchart of a DRX configuration method according to exemplary embodiments;

FIG. 5 is a flowchart of a DRX configuration method according to exemplary embodiments;

FIG. 6 is a structural block diagram of a DRX configuration apparatus according to exemplary embodiments;

FIG. 7 is a structural block diagram of a DRX configuration apparatus according to exemplary embodiments;

FIG. 8 is a structural block diagram of a DRX configuration apparatus according to exemplary embodiments;

FIG. 9 is a schematic diagram of a structure of a communication device according to exemplary embodiments; and

FIG. 10 is a schematic diagram of a structure of a communication device according to exemplary embodiments.

### DETAILED DESCRIPTION OF THE PREFERRED EMBODIMENTS

Some embodiments will be explained herein in detail, and examples are illustrated in the drawings. When referring to the drawings, unless otherwise indicated in the following descriptions, the same numerals in different drawings represent the same or similar elements. Implementations described in following embodiments do not represent all implementations consistent with the present disclosure. Instead, they are only examples of devices and methods consistent with some aspects of embodiments of the present disclosure as detailed in the attached claims.

Terms used in embodiments disclosed in the present disclosure are for the purpose of description of specific embodiments only, and are not intended to limit the embodiments of the present disclosure. Singular forms such as “a” and “the” used in embodiments of the present disclosure and the attached claims are also intended to include plural forms, unless other meanings are clearly indicated in the context. It should also be understood that the term “and/or” used herein refers to and includes any or all possible combinations of one or more related items listed.

It should be understood that although terms such as first, second, and third may be used to describe various information in embodiments of the present disclosure, these information should not be limited to these terms, which are only used to distinguish information of the same type from each other. For example, without departing from the scope of the present disclosure, the first information can also be referred to as the second information, and similarly, the second information can also be referred to as the first information. The word “if” and “in case” used herein can be interpreted as “when” or “while” or “in response to determination that”, depending on the context.

In order to better describe embodiments of the present disclosure, an application scenario of access control is taken as an example for illustrative explanation in one embodiment of the present disclosure.

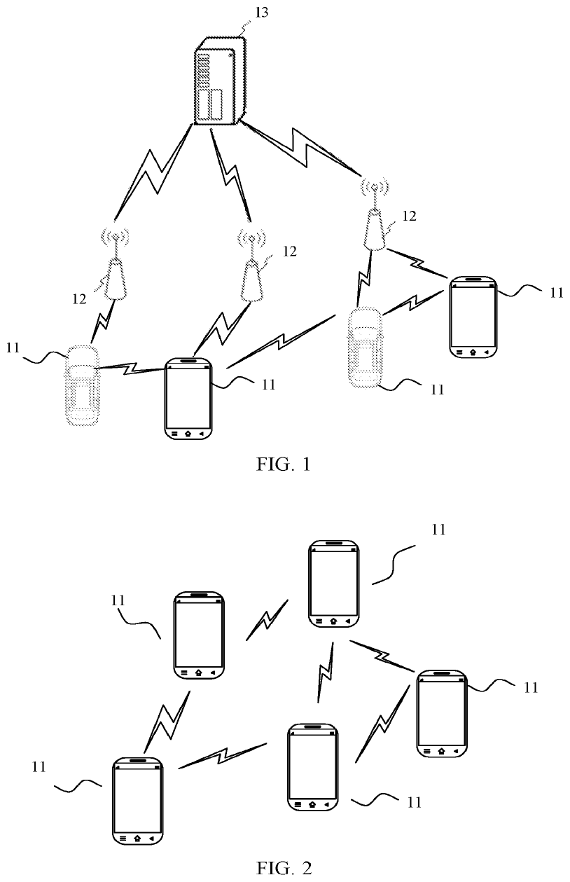

Reference is made to FIG. 1, which illustrates a schematic diagram of a structure of a wireless communication system provided by embodiments of the present disclosure. As shown in FIG. 1, the wireless communication system is a communication system based on cellular mobile communication technology, which may include several terminals 11 and several base stations 12.

The terminal 11 can be equipment that provides voice and/or data connectivity to a user. The terminal 11 can communicate with one or more core networks via a Radio Access Network (RAN). The terminal 11 can be an IoT (Internet of Things) terminal, for example, a sensor device, a mobile phone (or a “cellular” phone), and a computer with IoT terminals, such as fixed, portable, pocket, handheld, computer built-in, or vehicle mounted devices. For example, stations (STA), subscriber units, subscriber stations, mobile stations, mobiles, remote stations, access points, remote terminals, access terminals, user terminals, user agents, user devices or terminals. Alternatively, the terminal 11 can also be a device for unmanned aerial vehicles. Alternatively, the terminal 11 can also be an onboard device, such as a trip computer with wireless communication ability or wireless terminals connected to an external trip computer. Alternatively, the terminal 11 can also be a roadside device, such as a street light, a signal light, or other roadside devices with wireless communication ability.

Base station 12 can be a network side device in the wireless communication system. The wireless communication system can be the 4th generation (4G) mobile communication system, also known as Long Term Evolution (LTE) system. Alternatively, the wireless communication system can also be the 5th generation (5G) system, also known as New Radio system or 5G NR system. Alternatively, the wireless communication system can also be the next generation system following 5G system. The access network in 5G system can be referred to as the New Generation-Radio Access Network (NG-RAN).

Base station 12 can be the Evolved Node B (eNB) employed in 4G system. Alternatively, base station 12 can also be the next Generation Node B (gNB) constructed in a centralized and distributed architecture in 5G system. When constructed in the centralized and distributed architecture, base station 12 usually includes a central unit (CU) and at least two distributed units (DUs). The central unit is provided with a protocol stack consisting of the Packet Data Convergence Protocol (PDCP) layer, the Radio Link Control (RLC) layer, and the Medium Access Control (MAC) layer. The distributed unit is provided with a protocol stack of the Physical (PHY) layer. Specific implementations of base station 12 are not limited in embodiments of the present disclosure.

A wireless connection can be established between the base station 12 and the terminal 11 via a wireless air interface. In different implementations, the wireless air interface is based on the 4th generation (4G) mobile communication network technology standard. Alternatively, the wireless air interface is based on the 5th generation (5G) mobile communication network technology standard, for example, the wireless air interface is the New Radio. Alternatively, the wireless air interface can also be a wireless air interface based on the next generation mobile communication network technology standard following 5G.

In some embodiments, an E2E (End to End) connection can also be established between the terminal 11. For example, in vehicle to everything (V2X) communication, there are scenarios where vehicle to vehicle (V2V) communication, vehicle to infrastructure (V2I) communication, and vehicle to pedestrian (V2P) communication are established.

In some embodiments, the wireless communication system described above can also include a network management device 13.

Some of base stations 12 are respectively connected to the network management device 13. The network management device 13 can be a core network device in the wireless communication system, for example, the network management device 13 can be the Mobility Management Entity (MME) in the Evolved Packet Core (EPC). Alternatively, the network management device can also be other core network devices, such as the Service GateWay (SGW), the Public Data Network GateWay (PGW), the Policy and Charging Rules Function (PCRF), or the Home Subscriber Server (HSS). Implementations of the network management device 13 are not limited in embodiments of the present disclosure.

In some embodiments, in order to save power consumption of UE (User Equipment), the network can configure DRX for UE. When UE is in a connected state, the DRX configuration includes an inactivity timer, an on duration timer, a cycle and a starting offset, an uplink HARQ RTT (Hybrid Automatic Repeat Request Round-Trip Time) timer, a downlink HARQ RTT timer, an uplink retransmission timer, a downlink retransmission timer, etc. The cycle and the starting offset can be used to determine a periodic starting time point of the on duration timer. Each time when UE receives on the PDCCH (Physical Downlink Control Channel) the DCI (Downlink Control Information) carried with its own C-RNTI (Cell-Radio Network Temporary Identifier), it will activate the inactivity timer. UE listens to the PDCCH channel only during a wake-up period, and may not listen to the PDCCH channel at other times, thereby saving power consumption. After receiving a MAC PDU (Protocol Data Unit) and sending the feedback to the base station, UE activates the downlink HARQ RTT timer for the corresponding HARQ process. When the downlink HARQ RTT timer expires, UE activates the downlink retransmission timer. After sending the PUSCH transmission, UE activates the uplink HARQ RTT timer for the corresponding HARQ process. When the uplink HARQ RTT timer expires, UE activates the uplink retransmission timer. The wake-up period includes the on duration timer, the inactivity timer, the uplink retransmission timer, and the downlink retransmission timer operation.

In order to support direct communication between UE and UE, a Sidelink communication approach is introduced, and an interface between UE and UE is PC-5. As shown in FIG. 2, multiple terminals 11 are directly connected through SL. According to correspondence between Sending UE and Receiving UE, three transmission approaches are supported on SL, namely unicast, multicast, and broadcast.

UE needs to continuously monitor PSCCH (Physical Sidelink Control Channel) to obtain data sent by other UE. In order to save energy consumption of UE, a DRX function has been introduced on the Sidelink, and UE determines based on the DRX configuration whether itself is in an active state. In the active state, UE needs to listen to the PSCCH, while in a sleep state, UE does not need to listen to the PSCCH, which can reduce the time for listening to the PSCCH by UE and achieve the goal of saving power.

When UE autonomously selects transmission resources on the Sidelink, if adjacent UE chooses the same transmission resources, it may cause transmission collisions and reduce reliability. To avoid such collisions, a sensing mechanism has been introduced. UE needs to listen to SCI (Sidelink Control Information) sent by other UE continuously or for a period of time, to obtain resource selection information from other UE, so as to avoid selecting the same transmission resources when making resource selection. If sensing is not conducted on some resources, the resources cannot be selected during the resource selection.

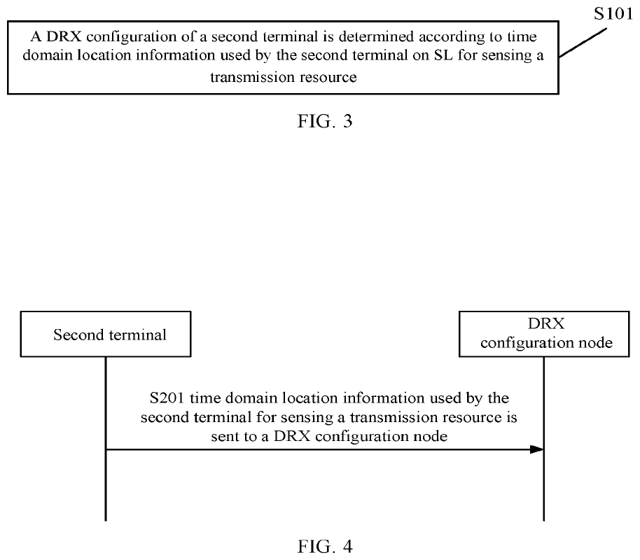

As shown in FIG. 3, embodiments of the present disclosure provide a DRX configuration method. The method is applied to a first terminal, and includes following step.

In step S101: a DRX configuration of a second terminal is determined according to time domain location information used by the second terminal on SL for sensing a transmission resource.

In some embodiments, the first terminal and the second terminal can be different terminals with SL established, and the first terminal and the second terminal can have direct communication. In some embodiments, the first terminal and the second terminal can be the same type of terminals, and also can be different types of terminals, such as mobile phones, tablets, smart watches, and various mobile communication devices.

In some embodiments, the time domain location information for sensing the transmission resource can include time, a cycle, duration, and an offset for the second terminal to perform sensing. The second terminal performs sensing on the transmission resource based on the time domain location information determined by itself.

In some embodiments, in order to enable the sensing on the transmission resource performed by the second terminal to be located in an active state period of the terminal corresponding to the DRX configuration, the first terminal can determine the DRX configuration of the second terminal based on the time domain location information of the second terminal.

The first terminal can determine a predetermined DRX configuration based on the time domain location information of the second terminal, or obtain the DRX configuration provided by the base station based on the time domain location information of the second terminal. The first terminal can also report the time domain location information to the base station and obtain the DRX configuration provided according to the time domain location information by the base station.

According to embodiments of the present disclosure, the DRX configuration of the second terminal is determined according to the time domain location information of the second terminal, so that the second terminal can be in an active state as far as possible when performing sensing on the transmission resource. As a result, a situation where the second terminal is unable to perform sensing due to being in a sleep state when performing the sensing can be reduced.

In some embodiments, a time period indicated by the DRX configuration, during which the second terminal enters the active state, overlaps at least partially with a time location indicated by the time domain location information.

In embodiments of the present disclosure, the DRX configuration can at least include time information when the second terminal enters the active state. For example, a cycle, an offset, and duration of the active state in the DRX configuration, or a cycle, an offset, and duration of the sleep state in the DRX configuration.

DRX refers to where the terminal periodically enters a sleep state, no longer listens to a PDCCH subframe in the sleep state, and again it listens when the terminal switches from the sleep state to an active state, thereby achieving the goal of saving power.

If the time period for sensing indicated by the time domain location information of the second terminal is in a sleep state period corresponding to the DRX configuration, the second terminal no longer listens to the PDCCH, and thus cannot perform sensing on the transmission resource, resulting in the inability to utilize the resource for data communication on SL by the second terminal.

In some embodiments, in order to enable the sensing on the transmission resource to be performed successfully by the second terminal, a time position indicated by the time domain location information of the second terminal may overlap at least partially with an active state period corresponding to the DRX configuration mentioned above.

In some embodiments, a DRX configuration can be made so that a time period (available for the second terminal to perform the sensing on the transmission resource) being in the active state is maximized.

In some embodiments, the method further includes the time domain location information is reported to the base station in response to determination that the first terminal is in a connected state.

In embodiments of the present disclosure, if the first terminal is in the connected state, an RRC connection is established between the first terminal and the base station, and data interaction can be conducted between the first terminal and the base station.

The first terminal can report the time domain location information of the second terminal to the base station, for the base station to determine the DRX configuration based on the time domain location information.

In some embodiments, the first terminal can determine the DRX configuration based on time domain location information, and report the time domain location information to the base station, enabling the base station to synchronously obtain the time domain location information of the second terminal.

In some embodiments, the time domain location information is used for the base station to determine and send the DRX configuration.

According to embodiments of the present disclosure, the first terminal reports the time domain location information to the base station, and the base station can directly determine the DRX configuration of the second terminal based on the time domain location information. The base station can send the DRX configuration of the second terminal to the first terminal. In some embodiments, if the second terminal is also in the connected state, the base station can also directly send the DRX configuration to the second terminal.

In some embodiments, that the DRX configuration of the second terminal is determined according to time domain location information used by the second terminal on SL for sensing a transmission resource includes, in response to determination that the first terminal is in an idle state or an inactive state, the DRX configuration of the second terminal is determined, based on the time domain location information, from the DRX configuration broadcast by the base station.

In embodiments of the present disclosure, if the first terminal is in the idle state or the inactive state, no RRC connection is established between the first terminal and the base station, and the first terminal cannot report the time domain location information to the base station. Therefore, the first terminal can then select the DRX configuration of the second terminal from the DRX configuration broadcast by the base station.

In some embodiments, the broadcast from the base station may only include one DRX configuration. If the DRX configuration causes a time period during which the terminal enters the active state to overlap at least partially with a time period for the sensing indicated by the time domain location information of the second terminal, the DRX configuration can be used as the DRX configuration of the second terminal.

In some embodiments, the DRX configuration broadcast by the base station includes multiple DRX configurations. That the DRX configuration of the second terminal is determined from the DRX configuration broadcast by the base station includes a DRX configuration resulting in a maximum overlapped duration between a duration indicating that the second terminal is in an active state and a duration for the sensing by the second terminal indicated by the time domain location information is determined, from the multiple DRX configurations, as the DRX configuration of the second terminal.

The broadcast from the base station can include multiple DRX configurations. The first terminal can select, based on the time domain location information of the second terminal, a DRX configuration with a maximum duration of corresponding active state during a time period for the second terminal to perform the sensing from the multiple DRX configurations, as the DRX configuration of the second terminal.

In some embodiments, within a DRX cycle corresponding to the DRX configuration, if there is a maximum overlapped duration between the active state period and the time period for the second terminal to perform the sensing, the DRX configuration can be selected. In some embodiments, within a predetermined duration, in multiple DRX cycles, if there is a maximum overlapped duration as a whole between the active state period and the time period for the second terminal to perform the sensing, the DRX configuration can be selected.

According to embodiments of the present disclosure, by selecting the DRX configuration, it is possible to ensure that the time period for the second terminal to perform the sensing is in the active state, while a time period when the second terminal is in the sleep state indicated by the DRX does not or as little as possible overlap(s) with the time period for sensing, thereby improving the effectiveness of sensing, so as to sense more resources as far as possible, and improve the resource utilization.

In some embodiments, that the DRX configuration of the second terminal is determined according to time domain location information used by the second terminal on SL for sensing a transmission resource includes, in response to determination that the first terminal is outside a coverage range of the base station, the DRX configuration of the second terminal is determined from a pre-configured DRX configuration, based on the time domain location information.

In embodiments of the present disclosure, if the first terminal is outside the coverage of the base station, the first terminal cannot have data communication with the base station and cannot receive the broadcast from the base station. Therefore, the first terminal can determine the DRX configuration of the second terminal from the pre-configured DRX configuration.

The pre-configuration can include one or more DRX configurations for the first terminal to select. The first terminal can select the DRX configuration with a maximum duration of corresponding active state during a time period for the second terminal to perform the sensing, based on the time domain location information of the second terminal, as the DRX configuration of the second terminal.

In some embodiments, the pre-configuration can be pre-configured information from the first terminal itself or the DRX configuration obtained from the broadcast from the base station in advance when the first terminal is within the coverage range of the base station.

In some embodiments, the pre-configured DRX configuration includes multiple DRX configurations. That the DRX configuration of the second terminal is determined from the pre-configured DRX configuration includes the DRX configuration of the second terminal resulting in a maximum overlapped duration between a duration indicating that the second terminal is in the active state and a duration indicated by the time domain location information for the second terminal to perform the sensing, is determined from the multiple DRX configurations as the DRX configuration of the second terminal.

According to embodiments of the present disclosure, by selecting the DRX configuration from the pre-configuration, it is possible to ensure that the time period for the second terminal to perform the sensing is in the active state as far as possible, thereby improving the effectiveness of sensing.

According to embodiments of the present disclosure, the first terminal determines the DRX configuration of the second terminal based on the time domain location information of the second terminal on SL. As a result, on one hand, even if no communication connection is established between the second terminal and the base station, the DRX configuration can be obtained. On the other hand, determining the DRX configuration based on the time domain location information of the second terminal facilitates sensing on the transmission resource by the second terminal in an active state corresponding to the DRX configuration, improving the reliability of resource sensing, and thus facilitating improving the resource utilization of data transmission on SL by the terminal.

As shown in FIG. 4, embodiments of the present disclosure provide a DRX configuration method. The method is applied to a second terminal, and includes the following step.

In step S201, time domain location information used by the second terminal for sensing a transmission resource is sent to a DRX configuration node. In some embodiments, the time domain location information is used by the DRX configuration node for determining a DRX configuration of the second terminal.

In embodiments of the present disclosure, the second terminal can determine the transmission resource on SL through sensing, and the second terminal determines the time domain location information for the second terminal itself to perform sensing on the transmission resource through a predetermined protocol or a factory setting.

The second terminal sends the time domain location information to the DRX configuration node, so as to facilitate the DRX configuration node to perform corresponding DRX configuration based on time domain location information. As a result, a sensing failure caused by the mismatch between the DRX configuration and the time period for the second terminal to perform the sensing can be reduced. The DRX configuration allows, as far as possible, sensing by the second terminal during a time period when the second terminal enters the active state, thereby improving the sensing efficiency.

It should be noted that the DRX configuration node herein can be other terminals that communicate with the second terminal on SL, and the DRX configuration node can also be network devices such as base stations.

In some embodiments, the method further includes the time domain location information is determined based on a sensing parameter for the second terminal to perform sensing on the transmission resource on SL.

In embodiments of the present disclosure, the second terminal can determine the corresponding time domain location information based on its own sensing parameter for sensing on SL. In some embodiments, the sensing parameter can be used to indicate when the second terminal starts sensing and stops sensing.

According to embodiments of the present disclosure, the second terminal can determine the time domain location information on its own, and can also determine the time domain location information mentioned above based on a sensing parameter specified in the protocol or indicated by other devices.

In some embodiments, the sensing parameter includes one or more of:
a sensing cycle;
a sensing offset; and
a sensing duration.

In some embodiments, the second terminal can periodically sense the transmission resource. Therefore, the second terminal itself can determine the sensing cycle, the sensing onfset, and the sensing duration for sensing.

In some embodiments, the sensing onfset can be an offset duration for the second terminal to start sensing within the sensing cycle, and the sensing duration is a duration during which the second terminal performs the sensing.

In embodiments of the present disclosure, the duration mentioned above can be an absolute time span, for example, n milliseconds. The duration can also be a logical duration, for example, n time slots, a time unit, etc.

The second terminal starts sensing at a starting position of the sensing onfset in each sensing cycle based on the sensing parameter mentioned above, and stops sensing after the sensing duration, until a starting position of the sensing onfset in next sensing cycle.

In some embodiments, a time period indicated by the DRX configuration, during which the second terminal enters the active state, at least partially overlaps with a time location indicated by the time domain location information.

In embodiments of the present disclosure, the DRX configuration at least includes time information when the second terminal enters the active state. For example, a cycle, an offset, and duration of the active state in the DRX configuration, or a cycle, an offset, and duration of the sleep state in the DRX configuration.

DRX refers to where the terminal periodically enters a sleep state, no longer listens to a PDCCH subframe in the sleep state, and again it listens when the terminal switches from the sleep state to an active state, thereby achieving the goal of saving power.

If the time period for sensing indicated by the time domain location information of the second terminal is in a sleep state period corresponding to the DRX configuration, the second terminal may no longer listen to the PDCCH, and thus it is difficult to perform sensing on the transmission resource, resulting in the inability to utilize the resource for data communication on SL by the second terminal.

In some embodiments, in order to enable the sensing on the transmission resource to be performed successfully by the second terminal, a time position indicated by the time domain location information of the second terminal at least partially overlaps with an active state period corresponding to the DRX configuration mentioned above.

In some embodiments, a DRX configuration can be made so that a time period being in the active state, available for the second terminal to perform the sensing on the transmission resource, is maximized.

In some embodiments, the DRX configuration node includes base station and/or the first terminal on the SL.

In embodiments of the present disclosure, the node that configures DRX for the second terminal can be the first terminal. The SL is established between the first terminal and the second terminal, and communication in unicast, multicast, or broadcast form can be conducted between them. Therefore, the second terminal can obtain its own DRX configuration from the first terminal.

The first terminal can configure DRX for the second terminal based on the time domain location information of the second terminal, or obtain the DRX configuration from the base station and provide the DRX configuration to the second terminal.

In embodiments of the present disclosure, the node that configures DRX for the second terminal can also be a base station. If a communication connection is directly established between the base station and the second terminal, the base station can directly configure DRX for the second terminal. For example, the base station receives the time domain location information from the first terminal and/or the second terminal, configures DRX for the second terminal and sends the DRX to the second terminal based on the time domain location information, or sends the DRX to the first terminal, so as to forward the DRX to the second terminal by the first terminal.

As shown in FIG. 5, embodiments of the present disclosure provide a DRX configuration method. The method is applied to a base station, and includes the following step.

In step S301, time domain location information for indicating sensing on a transmission resource on Sidelink (SL) by a second terminal is received. In some embodiments, the time domain location information is at least used for determination of the DRX configuration of the second terminal.

In some embodiments, the time domain location information for sensing the transmission resource can include the time, a cycle, duration, and an offset for the second terminal to perform sensing. The second terminal performs sensing on the transmission resource based on the time domain location information determined by itself.

In some embodiments, in order to enable the sensing on the transmission resource performed by the second terminal to be located in an active state period of the terminal corresponding to the DRX configuration, the DRX configuration of the second terminal can be determined based on the time domain location information of the second terminal.

The base station can configure DRX for the second terminal based on the time domain location information reported by the second terminal, or configure DRX for the second terminal based on the time domain location information of the second terminal reported by the first terminal. In some embodiments, the base station can directly send the DRX configuration to the second terminal, or to the first terminal, and then the DRX configuration is sent to the second terminal by the first terminal.

The first terminal and the second terminal are different terminals with SL established. The first terminal and the second terminal can perform Sidelink communication independent of the base station. Therefore, if no communication connection is established between the first terminal and the base station, the first terminal can obtain the DRX configuration from the second terminal.

According to embodiments of the present disclosure, the DRX configuration of the second terminal is determined according to the time domain location information of the second terminal, so that the second terminal can be in an active state as far as possible when performing sensing on the transmission resource. As a result, a situation where the second terminal is unable to perform sensing due to being in a sleep state when performing the sensing can be reduced.

In some embodiments, the method further includes at least one DRX configuration is sent based on the time domain location information. In some embodiments, the at least one DRX configuration includes at least the DRX configuration of the second terminal.

In some embodiments, the base station can configure DRX for the second terminal based on the time domain location information of the second terminal and send the DRX configuration to the second terminal. In addition, the base station can also configure DRXs for multiple terminals based on time domain location information from multiple terminals, and send multiple DRX configurations to the terminals in broadcast form. Alternatively, the base station is pre-configured with multiple DRXs and sends the multiple DRXs in broadcast form. The terminal (which can be the second terminal or the first terminal having established SL with the second terminal) selects the DRX configuration of the second terminal based on the time domain location information of the second terminal.

According to embodiments of the present disclosure, the DRX configuration of the second terminal is determined according to the time domain location information of the second terminal, so that the second terminal can be in an active state as far as possible when performing sensing on the transmission resource. As a result, a situation where the second terminal is unable to perform sensing due to being in a sleep state when performing the sensing can be reduced.

In some embodiments, that at least one DRX configuration is sent based on the time domain location information includes the at least one DRX configuration is sent to the first terminal based on the time domain location information. In some embodiments, the at least one DRX configuration is used for the first terminal to determine the DRX configuration of the second terminal. The first terminal is a terminal having established SL with the second terminal.

In some embodiments, the SL is established between the first terminal and the second terminal, which enables direct communication between them. The base station can send at least one DRX configuration to the first terminal based on the time domain location information of the second terminal. In some embodiments, the first terminal can select one DRX configuration from the at least one DRX configuration as the DRX configuration of the second terminal and send the DRX configuration to the second terminal via SL.

According to embodiments of the present disclosure, even if no communication connection is established between the second terminal and the base station, the DRX configuration can be obtained from the first terminal.

In some embodiments, the base station can receive the time domain location information reported by the second terminal and send at least one DRX configuration to the first terminal based on the time domain location information. For example, the SLs are established between the first terminal and multiple second terminals, the base station can configure multiple DRXs based on the time domain location information reported by the multiple second terminals, and then send the multiple DRXs to the first terminal. The first terminal can allocate different DRX configurations to different second terminals.

In some embodiments, the base station can also pre-configure multiple DRXs based on a predetermined protocol or a factory setting, and send the multiple DRXs to the first terminal. The first terminal then determines the DRX configuration of the second terminal based on the time domain location information of the second terminal.

In some embodiments, that time domain location information for indicating sensing on the transmission resource on the Sidelink (SL) by a second terminal is received includes:

the time domain location information of the second terminal reported by the first terminal is received.

In embodiments of the present disclosure, the SL is established between the first terminal and the second terminal. The second terminal may or may not have an established communication connection with the base station. The first terminal has an established communication connection with the base station, and data interaction can be conducted between the first terminal and the base station.

According to embodiments of the present disclosure, the first terminal can report the time domain location information of the second terminal to the base station. The base station receives the time domain location information reported by the first terminal, and can configure corresponding DRX and send the corresponding DRX to the first terminal. The first terminal then provides the corresponding DRX to the second terminal. In some embodiments, the first terminal can also carry identification information of the second terminal when reporting the time domain location information. After receiving the time domain location information reported by the first terminal, the base station can directly send the DRX configuration to the second terminal if the second terminal has established communication connection with the base station.

In some embodiments, that time domain location information for indicating sensing on the transmission resource on the Sidelink (SL) by a second terminal is received includes:

the time domain location information reported by the second terminal is received.

In embodiments of the present disclosure, if the second terminal has established communication connection with the base station, the second terminal can directly report the time domain location information determined by itself. The base station can determine the corresponding DRX configuration based on the time domain location information reported by the second terminal.

In some embodiments, a time period, indicated by the DRX configuration of the second terminal, during which the second terminal enters the active state, at least partially overlaps with a time location indicated by the time domain location information.

In embodiments of the present disclosure, the DRX configuration at least includes time information when the second terminal enters the active state. For example, a cycle, an offset, and duration of the active state in the DRX configuration, or a cycle, an offset, and duration of the sleep state in the DRX configuration.

DRX refers to where the terminal periodically enters a sleep state, no longer listens to a PDCCH subframe in the sleep state, and again it listens when the terminal switches from the sleep state to an active state, thereby achieving the goal of saving power.

If the time period for sensing indicated by the time domain location information of the second terminal is in a sleep state period corresponding to the DRX configuration, the second terminal no longer listens to the PDCCH, and thus cannot perform sensing on the transmission resource, resulting in the inability to utilize the resource for data communication on SL by the second terminal.

In some embodiments, in order to enable the sensing on the transmission resource to be performed successfully by the second terminal, a time position indicated by the time domain location information of the second terminal at least partially overlaps with an active state period corresponding to the DRX configuration mentioned above.

In some embodiments, a DRX configuration can be made so that a time period (available for the second terminal to perform the sensing on the transmission resource) being in the active state is maximized.

Embodiments of the present disclosure also provide following examples.

UE determines the time domain location for its sensing and sends the location for sensing to the node that determines the DRX configuration for SL.

The time domain location for sensing can be determined through the cycle, the offset, and the duration.

The node that determines the DRX configuration for SL can be a base station or a peer UE in a unicast connection.

In some embodiments, after receiving auxiliary information containing above time domain location, the peer UE will report the auxiliary information to the base station if it is in a connected state.

In some embodiments, after receiving the auxiliary information containing above time domain location, the peer UE will select a DRX configuration from the broadcast if it is in an idle or inactive state. A selection criterion is that the DRX configuration can maximize the duration during which UE is in the active state at a sensing position.

In some embodiments, the base station can carry multiple sets of DRX configurations in the broadcast for use by UE in the idle or inactive state.

In some embodiments, after receiving the auxiliary information containing above time domain location, the peer UE will select a DRX configuration from the pre-configuration if it is outside the coverage of the base station. A selection criterion is that the DRX configuration can maximize the duration during which UE is in the active state at a sensing position.

The pre-configuration mentioned above can carry multiple sets of DRX configurations.

In some embodiments, after receiving the auxiliary information containing above time domain location (which can be received from the UE or the peer UE), the base station configures SL DRX, so that the UE is in the active state at the sensing position.

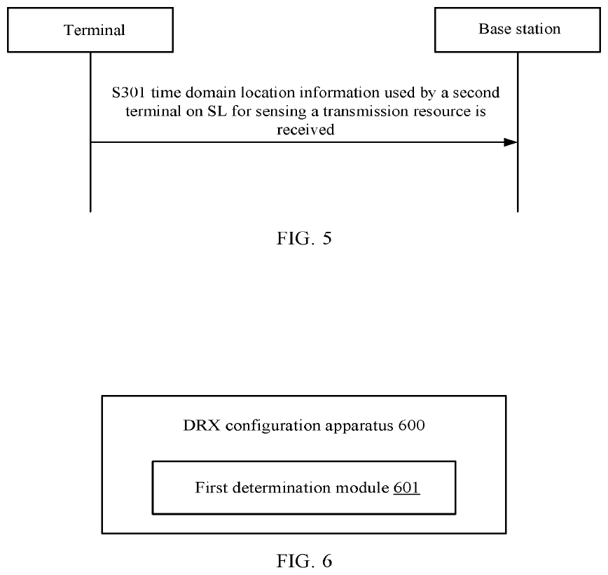

As shown in FIG. 6, embodiments of the present disclosure also provide a DRX configuration apparatus 600. The apparatus is applied to a first terminal, and includes a first determination module 601.

The first determination module 601 is configured to determine, according to time domain location information used by a second terminal on Sidelink (SL) for sensing a transmission resource, a DRX configuration of the second terminal.

In some embodiments, a time period indicated by the DRX configuration, during which the second terminal enters an active state, at least partially overlaps with a time location indicated by the time domain location information.

In some embodiments, the apparatus further includes a reporting module.

The reporting module is configured to report, in response to determination that the first terminal is in a connected state, the time domain location information to a base station.

In some embodiments, the time domain location information is used by the base station for determining sending of the DRX configuration.

In some embodiments, the first determination module includes a first determination submodule.

The first determination submodule is configured to determine, in response to determination that the first terminal is in an idle state or an inactive state, the DRX configuration of the second terminal from a DRX configuration broadcast by a base station according to the time domain location information.

In some embodiments, the DRX configuration broadcast by the base station includes multiple DRX configurations.

In some embodiments, the first determination submodule is specifically configured to determine, from the multiple DRX configurations, a DRX configuration resulting in a maximum overlapped duration between a duration indicating that the second terminal is in an active state and a duration for the sensing by the second terminal indicated by the time domain location information, as the DRX configuration of the second terminal.

In some embodiments, the first determination module includes a second determination submodule.

The second determination submodule is configured to determine, in response to determination that the first terminal is outside a coverage range of a base station, the DRX configuration of the second terminal from a pre-configured DRX configuration according to the time domain location information.

In some embodiments, the pre-configured DRX configuration includes multiple DRX configurations.

In some embodiments, the second determination submodule is specifically configured to determine, from the multiple DRX configurations, a DRX configuration resulting in a maximum overlapped duration between a duration indicating that the second terminal is in an active state and a duration for the sensing by the second terminal indicated by the time domain location information, as the DRX configuration of the second terminal.

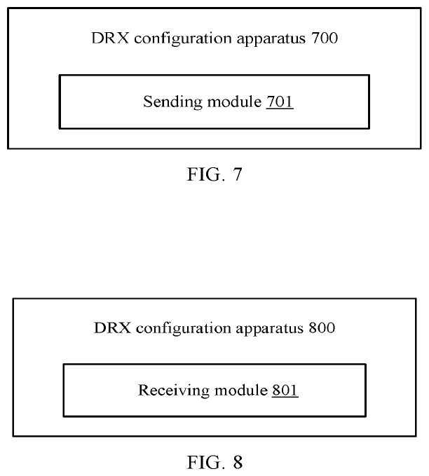

As shown in FIG. 7, embodiments of the present disclosure also provide a DRX configuration apparatus 700. The apparatus is applied to a second terminal, and includes a sending module (a first sending module) 701.

The sending module 701 is configured to send time domain location information used by the second terminal for sensing a transmission resource to a DRX configuration node. In some embodiments, the time domain location information is used by the DRX configuration node for determining a DRX configuration of the second terminal.

In some embodiments, the apparatus further includes a second determination module.

The second determination module is configured to determine, according to a sensing parameter used by the second terminal for sensing the transmission resource on SL, the time domain location information.

In some embodiments, the sensing parameter includes one or more of:
a sensing cycle;
a sensing offset; and
a sensing duration.

In some embodiments, a time period indicated by the DRX configuration, during which the second terminal enters an active state, at least partially overlaps with a time location indicated by the time domain location information.

In some embodiments, the DRX configuration nodes include a base station and/or a first terminal on SL.

As shown in FIG. 8, embodiments of the present disclosure also provide a DRX configuration apparatus 800. The apparatus is applied to a base station, and includes a receiving module 801.

The receiving module 801 is configured to receive time domain location information for indicating sensing on a transmission resource on Sidelink (SL) by a second terminal. In some embodiments, the time domain location information is at least for determination of the DRX configuration of the second terminal.

In some embodiments, the apparatus further includes a sending module (a second sending module).

The sending module is configured to send, according to the time domain location information, at least one DRX configuration. In some embodiments, the at least one DRX configuration includes at least the DRX configuration of the second terminal.

In some embodiments, the sending module includes a sending submodule.

The sending submodule is configured to send, according to the time domain location information, the at least one DRX configuration to a first terminal. In some embodiments, the at least one DRX configuration is used by the first terminal for determining the DRX configuration of the second terminal, and the first terminal is a terminal having an established SL with the second terminal.

In some embodiments, the receiving module includes a first receiving submodule.

The first receiving submodule is configured to receive the time domain location information of the second terminal reported by the first terminal.

In some embodiments, the receiving module includes a second receiving submodule.

The second receiving submodule is configured to receive the time domain location information reported by the second terminal.

In some embodiments, a time period indicated by the DRX configuration of the second terminal, during which the second terminal enters an active state, at least partially overlaps with a time location indicated by the time domain location information.

Specific ways in which each module of the apparatus in above embodiments performs operations have been explained in detail in related method embodiments, and will not be repeated herein.

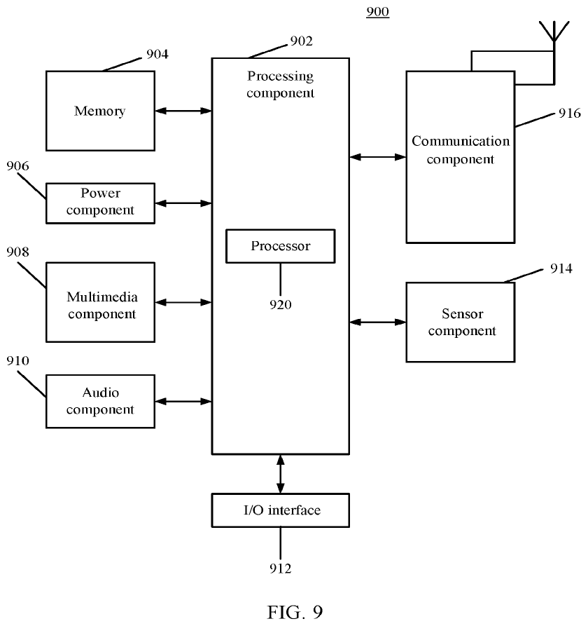

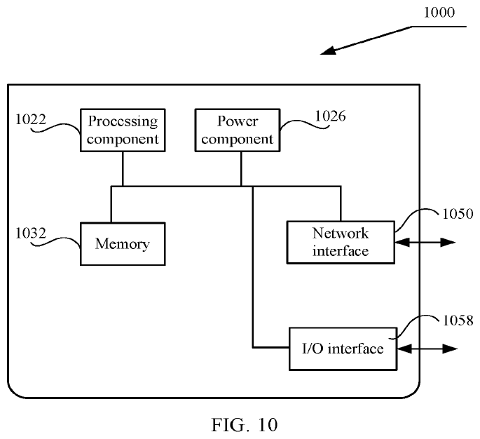

FIG. 9 illustrates a schematic diagram of a structure of a communication device according to some embodiments. The communication device can be a terminal. For example, communication device 900 can be a mobile phone, a computer, a digital broadcasting user device, a messaging device, a game console, a tablet device, a medical device, a fitness device, a personal digital assistant, etc.

Referring to FIG. 9, communication device 900 can include at least one of the following components: a processing component 902, a memory 904, a power component 906, a multimedia component 908, an audio component 910, an input/output (I/O) interface 912, a sensor component 914, and a communication component 916.

The processing component 902 typically controls the overall operation of the communication device 900, such as operations associated with display, telephone call, data communication, camera operation, and recording operations. The processing component 902 may include one or more processors to execute instructions to complete all or part of the methods described above. In addition, the processing component 902 may include one or more modules to facilitate interactions between the processing component 902 and other components. For example, the processing component 902 may include a multimedia module to facilitate interaction between the multimedia component 908 and the processing component 902.

The memory 904 is configured to store various types of data to support operations in the communication device 900. Examples of such data include instructions, contact data, phone book data, messages, pictures, videos, and the like for any application or method operating on the communication device 900. The memory 904 can be implemented by any type of volatile or non-volatile storage device or their combination, such as static random access memory (SRAM), electrically erasable programmable read-only memory (EEPROM), erasable programmable read-only memory (EPROM), programmable read-only memory (PROM), read-only memory (ROM), magnetic memory, flash memory, disk or optical disk.

The power component 906 provides power for various components of the communication device 900. The power component 906 may include a power management system, one or more power supplies, and other components associated with generating, managing, and distributing power for the communication device 900.

The multimedia component 908 includes a display screen providing an output interface between the communication device 900 and the user. In some embodiments, the screen may include a liquid crystal display (LCD) and a touch panel (TP). If the screen includes a touch panel, the screen can be implemented as a touch screen to receive input signals from the user. The touch panel includes one or more touch sensors to sense touch, sliding, and gestures on the touch panel. The touch sensor can not only sense the boundaries of touch or sliding actions, but also detect the duration and pressure related to the touch or sliding operation. In some embodiments, the multimedia component 908 includes a front camera and/or a rear camera. When the communication device 900 is in operation mode, such as shooting mode or video mode, the front camera and/or rear camera can receive external multimedia data. Each front camera and rear camera can be a fixed optical lens system or have focal length and optical zoom capability.

The audio component 910 is configured to output and/or input audio signals. For example, the audio component 910 includes a microphone (MIC), which is configured to receive an external audio signal when the communication device 900 is in an operation mode, such as a calling mode, a recording mode, and a voice recognition mode. The received audio signal may be further stored in memory 904 or transmitted via communication component 916. In some embodiments, the audio component 910 also includes a speaker for outputting audio signals.

The I/O interface 912 provides an interface between the processing component 902 and peripheral interface modules, which can be a keyboard, click wheel, button, etc. These buttons may include, but are not limited to, the Home button, Volume button, Start button, and Lock button.

The sensor component 914 includes one or more sensors for providing various aspects of condition evaluation for the communication device 900. For example, the sensor component 914 can detect an open/closed state of the communication device 900, relative positioning of the components. The component is, for example, a display and a keypad of the communication device 900. The sensor component 914 can also detect changes in the position of the communication device 900 or one component of the communication device 900, presence or absence of the user's contact with the communication device 900, orientation or acceleration/deceleration of the communication device 900 and temperature change of the communication device 900. The sensor component 914 may include a proximity sensor configured to detect the presence of nearby objects without any physical contact. The sensor component 914 may also include a light sensor, such as a CMOS or CCD image sensor, for use in imaging applications. In some embodiments, the sensor component 914 may also include an acceleration sensor, a gyroscope sensor, a magnetic sensor, a pressure sensor, or a temperature sensor.

The communication component 916 is configured to facilitate wired or wireless communication between the communication device 900 and other devices. The communication device 900 can access wireless networks based on any communication standards, such as WiFi, 2G or 3G, or a combination thereof. In some embodiments, the communication component 916 receives a broadcast signal or broadcast related information from an external broadcast management system via a broadcast channel. In some embodiments, the communication component 916 also includes a near field communication (NFC) module to facilitate short range communication. For example, the NFC module can be implemented based on radio frequency identification (RFID) technology, infrared data association (IrDA) technology, ultra wideband (UWB) technology, Bluetooth (BT) technology and other technologies.

In some embodiments, the communication device 900 can be implemented through one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components, for implementing above methods.

In some embodiments, a non-transitory computer-readable storage medium including instructions is also provided, such as a memory 904 including instructions, which can be executed by a processor of the communication device 900 to complete above methods. For example, the non-transitory computer-readable storage medium can be ROM, random access memory (RAM), CD-ROM, tapes, floppy disks, optical data storage devices, etc.

As shown in FIG. 10, embodiments of the present disclosure illustrate a structure of another communication device. The communication device can be a base station according to embodiments of the present disclosure. For example, communication device 1000 can be provided as a network side device. Referring to FIG. 10, the communication device 1000 includes a processing component 1022, which further includes one or more processors, as well as memory resources represented by a memory 1032, for storing instructions that can be executed by the processing component 1022, such as application programs. The application programs stored in memory 1032 may include one or more modules corresponding to a set of instructions. In addition, the processing component 1022 is configured to execute instructions to execute any of the methods applied to the base station described above.

The communication device 1000 may also include a power component 1026 configured to perform power management of the communication device 1000, a wired or wireless network interface 1050 configured to connect the communication device 1000 to the network, and an input and output (I/O) interface 1058. The communication device 1000 can operate operating systems stored on the memory 1032, such as Windows Server™, Mac OS X™, Unix™, Linux™, FreeBSD™, or similar systems.

After considering the specification and practices disclosed herein, those skilled in the art will easily come up with other implementation solutions of the present disclosure. The present disclosure aims to cover any variations, uses, or adaptive changes of the present disclosure, which follow the general principles of the present disclosure and include common knowledge or commonly used technical means in the art that are not disclosed in the present disclosure. The specification and embodiments are only considered exemplary, and the true scope and spirit of the present disclosure are defined by appended claims.

It should be understood that the present disclosure is not limited to the precise structure described above and shown in the drawings, and various modifications and changes can be made without departing from its scope.

1. A Discontinuous Reception (DRX) configuration method, performed by a first terminal, comprising:
determining, according to time domain location information used by a second terminal on Sidelink (SL) for sensing a transmission resource, a DRX configuration of the second terminal.

2. The method according to claim 1, wherein a time period indicated by the DRX configuration, during which the second terminal enters an active state, at least partially overlaps with a time location indicated by the time domain location information.

3. The method according to claim 1, further comprising:
reporting, in response to determination that the first terminal is in a connected state, the time domain location information to a base station.

4. The method according to claim 3, wherein the time domain location information is used by the base station for determining sending of the DRX configuration.

5. The method according to claim 1, wherein determining, according to the time domain location information used by the second terminal on SL for sensing the transmission resource, the DRX configuration of the second terminal comprises:
determining, in response to determination that the first terminal is in an idle state or an inactive state, the DRX configuration of the second terminal from a DRX configuration broadcast by a base station according to the time domain location information.

6. The method according to claim 5, wherein the DRX configuration broadcast by the base station comprises multiple DRX configurations, and determining the DRX configuration of the second terminal from the DRX configuration broadcast by the base station comprises:
determining, from the multiple DRX configurations, a DRX configuration resulting in a maximum overlapped duration between a duration indicating that the second terminal is in an active state and a duration for the sensing by the second terminal indicated by the time domain location information, as the DRX configuration of the second terminal.

7. The method according to claim 1, wherein determining, according to the time domain location information used by the second terminal on SL for sensing the transmission resource, the DRX configuration of the second terminal comprises:
determining, in response to determination that the first terminal is outside a coverage range of a base station, the DRX configuration of the second terminal from a pre-configured DRX configuration according to the time domain location information.

8. The method according to claim 7, wherein the pre-configured DRX configuration comprises multiple DRX configurations, and determining the DRX configuration of the second terminal from the pre-configured DRX configuration comprises:
determining, from the multiple DRX configurations, a DRX configuration resulting in a maximum overlapped duration between a duration indicating that the second terminal is in an active state and a duration for the sensing by the second terminal indicated by the time domain location information, as the DRX configuration of the second terminal.

9. A Discontinuous Reception (DRX) configuration method, performed by a second terminal, comprising:
sending time domain location information used by the second terminal for sensing a transmission resource to a DRX configuration node, wherein the time domain location information is used by the DRX configuration node for determining a DRX configuration of the second terminal.

10. The method according to claim 9, further comprising:
determining, according to a sensing parameter used by the second terminal for sensing the transmission resource on SL, the time domain location information.

11. The method according to claim 10, wherein the sensing parameter comprises one or more of:
a sensing cycle;
a sensing offset; and
a sensing duration.

12. The method according to claim 9, wherein a time period indicated by the DRX configuration, during which the second terminal enters an active state, at least partially overlaps with a time location indicated by the time domain location information.

13. The method according to claim 9, wherein the DRX configuration node comprises at least one of a base station and a first terminal on SL.

14. A Discontinuous Reception (DRX) configuration method, performed by a base station, comprising:
receiving time domain location information for indicating sensing on a transmission resource on Sidelink (SL) by a second terminal, wherein the time domain location information is at least for determination of the DRX configuration of the second terminal.

15. The method according to claim 14, further comprising:
sending, according to the time domain location information, at least one DRX configuration, wherein the at least one DRX configuration comprises at least the DRX configuration of the second terminal.

16. The method according to claim 15, wherein sending, according to the time domain location information, at least one DRX configuration comprises:
sending, according to the time domain location information, the at least one DRX configuration to a first terminal, wherein the at least one DRX configuration is used by the first terminal for determining the DRX configuration of the second terminal, and the first terminal is a terminal having an established SL with the second terminal.

17. The method according to claim 16, wherein receiving the time domain location information for indicating sensing on the transmission resource on Sidelink (SL) by the second terminal comprises:
receiving the time domain location information of the second terminal reported by the first terminal.

18. The method according to claim 14, wherein receiving the time domain location information for indicating sensing on the transmission resource on Sidelink (SL) by the second terminal comprises:
receiving the time domain location information reported by the second terminal.

19. The method according to claim 14, wherein a time period indicated by the DRX configuration of the second terminal, during which the second terminal enters an active state, at least partially overlaps with a time location indicated by the time domain location information.

20-40. (canceled)

41. The method according to claim 6, wherein determining, from the multiple DRX configurations, a DRX configuration resulting in a maximum overlapped duration between a duration indicating that the second terminal is in an active state and a duration for the sensing by the second terminal indicated by the time domain location information, as the DRX configuration of the second terminal comprises:
determining, within a predetermined duration, a DRX configuration resulting in a maximum overlapped duration as a whole in multiple DRX cycles between a duration indicating that the second terminal is in an active state and a duration for the sensing by the second terminal indicated by the time domain location information, as the DRX configuration of the second terminal.
